(19) United States
(12) Patent Application Publication
(10) Pub. No.: US 2023/0358135 A1
(43) Pub. Date: Nov. 9, 2023

(54) System and Method for Ascertaining Location

(71) Applicant: McKelley Equipment, LLC, Gretna, NE (US)

(72) Inventor: Larry MCKENNAN, Fort Calhoun, NE (US)

(21) Appl. No.: 18/143,477

(22) Filed: May 4, 2023

Related U.S. Application Data
(60) Provisional application No. 63/338,326, filed on May 4, 2022.

(51) Int. Cl. E21B 47/12; G05B 19/05

(52) U.S. Cl. CPC E21B 47/12; G05B 19/058; G05B 2219/15117

(57) ABSTRACT

A system and method for ascertaining location of a tool. The system includes at least one actuator with an encoders and at least one carrier vehicle coupled with the actuator. The method includes coupling a carrier vehicle to a tool. The tool is coupled to a plurality of actuators which are coupled to encoders. The actuators are instructed to move the tool. The movement of the actuators are recorded. This allows the final location of the tool to be calculated based on the movement of the actuators. This system can eliminate the need for hydraulic lines.

### PRIORITY

The present invention claims priority to U.S. Provisional No. 63/338,326 filed May 4, 2022, the entirety of which is hereby incorporated by reference.

### BACKGROUND OF THE INVENTION

### Technical Field

The present invention relates to a system and method for ascertaining location of a tool.

### Description of Related Art

Rock drilling is performed using complicated hydraulic circuits which consist of valves, pumps, reservoirs, hoses, fittings, and cylinders. The systems can also utilize sensors which are susceptible to damage and require constant recalibration. Such systems use vast hydraulic hoses and fittings which are prone to damage and leaking. Consequently, there is a need to eliminate the need for such components while still knowing the precise location of equipment.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic view of a system with hydraulic lines;

FIG. 2 is a schematic view of a system with a linear actuator in one embodiment;

FIG. 3 is a schematic view of a system with rotary and linear actuators in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

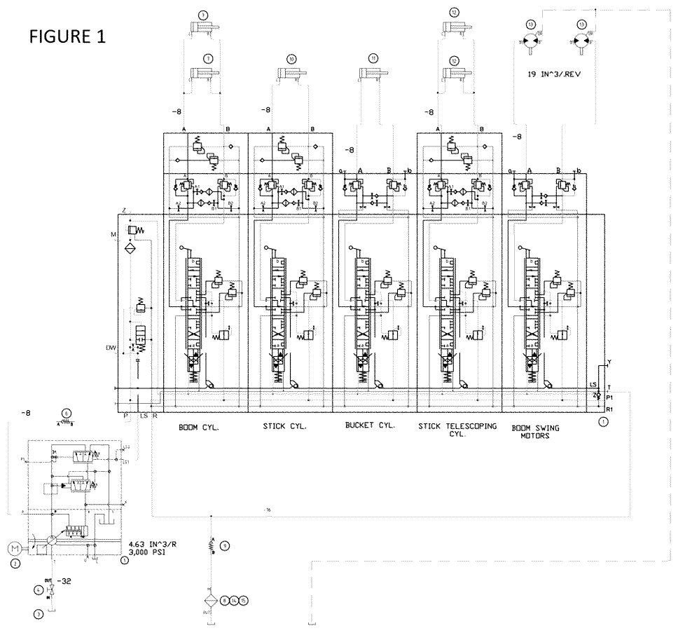

FIG. 1 is a schematic view of a system with hydraulic lines. As can be seen the lines are complex. This adds to capital cost. Further, each hydraulic line is prone to leak or damage. This increases the likelihood of environmental contamination as well as downtime due to maintenance. In one embodiment, the complex hydraulic lines shown in FIG. 1 are eliminated, greatly simplifying the manual and automatic positioning of rock drilling machines. Thus, in one embodiment the system for ascertaining location does not comprise any hydraulic lines.

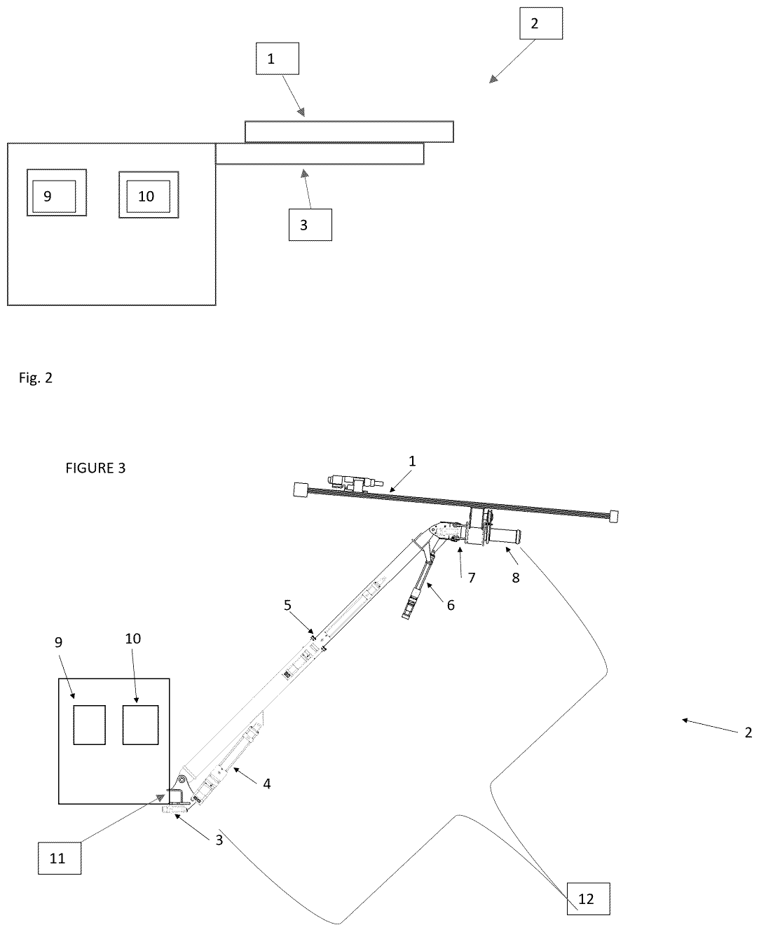

FIG. 2 is a schematic view of a system with a linear actuator in one embodiment. FIG. 2 is simplified to aid in understanding. Support equipment and electrical lines have been deleted for simplicity.

While one embodiment will discuss drilling a drilling fixture, the term “drilling” is used for illustrative purposes only and should not be deemed limiting. The system and method disclosed herein can include drilling, tunnelling, mining, blasting, etc. Previously, accurate patterns and alignment during drilling were difficult or impossible. However, the system and method disclosed herein provides for automating this process using, in one embodiment, a multi axis electrically actuated system.

FIG. 2 shows a drilling fixture 2. As noted, while the term “drilling fixture” is used, the fixture can be used for any of the processes discussed herein and is not limited to drilling. The drilling fixture 2 can be added to an independent carrier or other common construction or power equipment. This independent carrier can include, but is not limited to, a forklift, telehandler, excavator, loader, skid steer, etc. The carrier will carry and deploy the drilling fixture 2. The drilling fixture 2, in combination with the carrier, can be used for cutting, spraying, drilling, marking, installing, tunneling, mining, blasting, etc.

As noted, one embodiment is discussed herein where the complicated, complex, capitally intensive hydraulic lines are replaced by an electrical line which can power the actuators is disclosed. Thus, rather than complex, and prone to failing, hydraulic lines, an electrical line is utilized instead.

FIG. 2 shows a tool 1 coupled to the drilling fixture 2. Virtually any tool can be utilized on the system described herein. As noted, the system described herein provides accurate location information. Virtually any equipment which moves can benefit from this system. Further, any equipment which utilizes tools which require accurate placement can benefit from the technology discussed herein.

The drilling fixture 2 can be added in a variety of ways depending upon the carrier utilized. It can be coupled via any method or device known in the art including bolting, welding, etc. In one embodiment the drilling fixture 2 is removeably coupled such that the fixture 2 can be added and removed from the carrier as desired.

As noted, FIG. 2 shows a simplified structure to aid in the understanding of the mechanism. FIG. 2, broadly, shows an electrically actuated and controlled system which can be attached to other equipment to both carry the system, and perform the primary functions of the system. The actuators can comprise linear actuators, as shown in FIG. 2, or rotary actuators as shown in FIG. 3. The actuators, in one embodiment, are driven by an AC or DC electrical power as appropriate to the carrier. The control system, in one embodiment, comprises a computer numerical control and sensors, such as encoders, to provide location feedback. This allows the system to be driven using integrated or separate controls to specific positions and alignment. In one embodiment the encoders are coupled to the actuators. In one embodiment the encoders are located on the actuators. In another embodiment, however, the encoders are coupled with the servo motor. The encoders allow the movement of the actuators to be precisely monitored and controlled. By knowing, for example, how many cycles a encoder has completed, the lateral distance is known with great certainty.

FIG. 2 shows the tool 1. As shown, the tool 1 is coupled to a servo linear actuator 3. A tool 1, as used herein, refers to any tool which is used to accomplish the desired task. The tool 1 can comprise a drill feed, tools to blast rock, tools to drill rock, etc. Virtually any tool used in the tasks identified herein can be used as the tool 1. In one embodiment, the tool 1 is directly or indirectly coupled to at least one actuator. As shown in FIG. 3, discussed in more detail below, the tool 1 can be coupled to a boom or other structure which is coupled, directly or indirectly, with at least one actuator, or a plurality of actuators. A servo actuator, as used herein, refers to a device which is used to rotate or push/pull a part with precision. The servo actuator can comprise, in one embodiment, a servo linear actuator or a rotary actuator. The servo linear actuator, in one embodiment, uses an electric motor to control movement linearly. As shown the actuator 3 moves the tool 1 laterally in the horizontal position.

In one embodiment the servo actuator comprises encoders. The encoders can be used with the programmable logic controller 9 and the servo driver 10 to accurately determine the location of the tool 1. This allows the operator to know precisely where the tool 1 is located. It ensures that the system is drilling in the desired location. In one embodiment there is one encoder for each actuator.

Virtually any servo actuators can be utilized. So long as the movements are precise and controlled, the encoders and the PLC 9 can determine the location of the tool 1.

The drilling fixture 2 can be powered via any method or device known in the art. It can be powered by the independent carrier, or it can be separately powered by a battery, the grid, or any other power source.

FIG. 2 shows a simplified version of the drilling fixture 2 which can only move or advance in the horizontal direction. Further, FIG. 2 shows a simplified version wherein the drilling fixture 2 comprises only a single servo linear actuator 3. However, this is for illustrative purposes only and should not be deemed limiting. In other embodiments, as described in more detail below, a plurality of linear actuators and/or rotary actuators allows positioning and control of the tool 1 both vertically, horizontally, and at virtually any desired angle. In usage, if the operator desires the tool 1 to be moved forward laterally, then then actuator 3 is engaged. The actuator, using a servo, moves the tool 1 forward laterally the desired distance. The distance is calculated and recorded by sensing the encoder which is coupled to the actuator 3. Knowing the distance recorded by the encoder, the PLC 9 can determine the location of the tool 1. The tool 1 can be coupled directly to the actuator 3, or it can be coupled to other support structure. Either way, the distance traveled, and therefore the ending location of the tool 1, can be calculated. Knowing how much the actuator 3 moves, and knowing the beginning location of the tool 1, allows the PLC to accurately calculate the ending location of the tool 1.

FIG. 3 is a schematic view of a system with rotary and linear actuators in one embodiment. In one embodiment actuators 3, 4, 6, 7 comprise rotary joints which are powered by a linear actuator. In one embodiment the rotary actuator 8 comprises a rotary joint powered by a rotary actuator. In one embodiment linear actuator 5 provides linear movement of the boom 12, as discussed in more detail below. As can be seen, various actuators can be utilized. This specific example and selection of actuators is shown for illustrative purposes only and should not be deemed limiting.

As shown, the tool 1 is coupled to a servo rotary actuator 8. The servo rotary actuator 8 allows the tool 1 to be rotated about the servo rotary actuator 8.

As shown, actuators 3, 4, 5, 6, 7, and 8, are used in multiple configurations to move and rotate the tool 1 position. The servo linear actuators can move in the horizontal orientation, vertical orientation, or some of each, as shown. This allows the tool 1 to be accurately positioned as desired.

The first actuator shown, is the linear rotation actuator 3, which is used to rotate the angle between the attachment point 11 and the boom 12. The boom 12 is structure which couples the independent vehicle to the tool 1. The boom 12 can directly or indirectly couple the vehicle to the tool 1. In one embodiment the system can comprise a plurality of booms 12. The actuators can be located atop, at the ends, or inside the boom 12. Thus, in one embodiment the actuators are placed on, along, or inside of the boom 12 to provide movement of the boom 12. As shown, if linear rotation actuator 4 is shortened, the boom 12 is lowered relative to the attachment point 11. If, however, the actuator 4 is lengthened, the boom 12 is raised relative to the attachment point 11. Actuator 3, as shown, controls the angle perpendicular to the angle controlled by actuator 4—specifically the angle into or away from the page. The same can be said for the base elevation actuator 4 which likewise controls the angle, in the embodiment depicted.

In the embodiment depicted, the boom extension actuator 5 controls the length of the boom 12. The length of the boom 12 can be lengthened or shortened by movement of the boom extension actuator 5. Thus, in one embodiment the boom 12 has an adjustable length. In one embodiment the attachment angle, the angle at which the boom 12 and the vehicle are coupled, is adjustable.

Also depicted are four linear actuators 3, 4, 6, 7 driving rotary joints and a rotary actuator 8. A rotary actuator is an actuator which produces rotary motion or torque. A rotary actuator allows the angle of attack to be adjusted. While only one rotary actuators 8 is depicted, this is for illustrative purposes only and should not be deemed limiting. Virtually any number of rotary actuators can be utilized depending upon the desired application. As noted, in one embodiment linear rotary actuators 3, 4, 6, 7 comprise rotary joints which are powered by a linear actuator. Conversely, in one embodiment the rotary actuator 8 comprises a rotary joint powered by a rotary actuator. The actual actuators utilized, and their location, can vary depending upon the desired application.

The vertical wrist rotation actuator 6 allows the tool 1 to rotate about the axis on the vertical wrist rotation actuator 6. Similarly, the horizontal wrist rotation actuator 7 allows the tool 1 to rotate about the horizontal wrist rotation actuator 7.

In one embodiment, like the servo linear actuators, the rotary actuators also have encoders. This allows their position to be accurately tracked and monitored.

In one embodiment the system provides at least one degree of freedom of movement. In other embodiments, the system provides greater than one degree of freedom. In still other embodiments, the system offers 5 or 6 degrees of freedom. This allows the tool 1, or other such tool, to be accurately placed in the desired location. Further, due to the actuators and/or encoders, the precise location of the tool 1 is known at all times.

While a system has been described, a method of ascertaining location will be described. First, the carrier is equipped with a tool. The tool is coupled to at least one actuator. In one embodiment the tool is coupled to a plurality of actuators. Each actuator is coupled to an encoder. The encoders are in communication with a PLC 9. The operator, either a controller or a human user, instructs the equipment to move the tool. In response, the actuators move as necessary to advance said tool. The actuator adjusts the specified distance. The movement of the actuators is recorded. In one embodiment the encoder verifies the distance and transmits such data to the PLC 9. The PLC 9, armed with the data from the actuator(s), calculates the final location of the tool based on the movement of the actuator(s). In one embodiment the calculation comprises knowing the first location of the tool and using the movement of the actuators to determine the final location of the tool. The starting/first location of the equipment can be manually inputted, or it can be obtained through automatic methods such as GPS, etc. The location of the equipment is then stored. After subsequent movements, the PLC 9 calculates the final location based upon the movements and the starting position.

If the system includes rotary actuators, the PLC 9 will use the data from the rotary actuators to determine movement, location, vertical movement, horizontal movement, etc. In this manner, armed with the initial starting location, the system can determine the precise location after a series of movements.

The system described herein allows for accurate placement and controlled movement of the tool 1, or other tools or equipment. The system determines the movement and placement of the tool 1. Accordingly, the system knows the precise location of the tool 1. This is a huge advantage over the prior art. Often more than one piece of equipment is drilling or other operations. Accordingly, knowing precisely where each piece of equipment is operating is a significant advantage.

While an embodiment has been described using encoders, in another embodiment the system comprises a plurality of sensors to sense, determine, and measure movement. The data collected from the sensors can be utilized by the PLC to calculate and determine the location of a tool.

While one embodiment has been described using a single tool, in other embodiments a plurality of tools are monitored. Because the precise location of the equipment is obtained, this is a benefit for logistics as well as strategy in drilling, for example. As but one example, if one piece of equipment goes down or needs repair, a second piece of equipment can be placed in the same location. The second piece of equipment can then begin drilling at the same location, and at the same angle of attack as the previous equipment. The location of the second piece of equipment can be entered into the control system, and the control system can execute a series of commands to position the second tool in the same or similar location as the first tool.

Further, as noted previously, prior systems required extensively complex hydraulic and electric lines. These complex lines are often difficult to install. Further, with so many lines, moving parts, joints, etc., they are prone to fatigue and eventually breaking or fouling. Troubleshooting a complex network of lines is time-consuming and results in significant downtime.

Aside from reduction of costly downtime, eliminating the need for such lines reduces the capital cost of the equipment. Actuators are often a fraction of the cost of the complex hydraulic systems and lines previously utilized. The resulting system is often less expensive to obtain, less expensive to operate, and produces very accurate location information.

While the invention has been particularly shown and described with reference to a preferred embodiment, it will be understood by those skilled in the art that various changes in form and detail may be made therein without departing from the spirit and scope of the invention.

What is claimed is:

1. A system for ascertaining location, said system comprising:
at least one actuator coupled to an encoder;
at least one carrier vehicle coupled with said actuator.

2. The system of claim 1 further comprising at least one rotary actuator.

3. The system of claim 1 wherein said at least one actuator comprises a plurality of linear actuators.

4. The system of claim 1 further comprising a PLC and a servo driver.

5. The system of claim 1 further comprising at least four linear actuators and at least one rotary actuators.

6. The system of claim 1 further comprising a tool coupled to said system.

7. The system of claim 6 wherein said tool is used for drilling.

8. The system of claim 6 further comprising a PLC, wherein said PLC determines the location of said tool based on information from said at least one actuator.

9. The system of claim 8 wherein said PLC determines the location of said tool based on information from a plurality of actuators.

10. The system of claim 1 wherein said system does not comprise any hydraulic lines.

11. The system of claim 1 further comprising a boom which couples said independent vehicle with a tool.

12. The system of claim 11 wherein said boom has an adjustable length.

13. The system of claim 11 wherein the angle at which the boom and the vehicle are coupled, is adjustable.

14. A method of ascertaining location of a tool, said method comprising the steps of:
a) coupling a carrier vehicle to a tool, wherein said tool is coupled to a plurality of actuators, each actuator coupled to an encoder;
b) instructing the plurality of actuators to move said tool;
c) recording movement of said actuators;
d) calculating a final location of said tool based on the movement of said actuators.

15. The method of claim 14 further comprising the step of determining a first location of said tool.

16. The method of claim 15 wherein said determining a first location comprises obtaining a first location through GPS.

17. The method of claim 14 wherein said method does not utilize hydraulic lines.
